(19) United States
(12) Patent Application Publication
(10) Pub. No.: US 2019/0197605 A1
(43) Pub. Date: Jun. 27, 2019

(54) CONVERSATIONAL INTELLIGENCE ARCHITECTURE SYSTEM

(71) Applicant: Symphony RetailAI, Surrey (GB)

(72) Inventors: Stuart Sadler, London (GB); Ayaz Ali, London (GB); Aabhas Chandra, The Colony, TX (US); Withiel Cole, Cirencester (GB); Andrew Harris, Milton Keynes (GB); Vishal Kirpalani, McKinney, TX (US); Ernesto Laval, Temuco (CL); Tristan Maw, Quincy, MA (US); Stephanie Seiermann, London (GB); Pallab Chatterjee, Plano, TX (US)

(73) Assignee: Symphony RetailAI, Surrey (GB)

(21) Appl. No.: 16/221,320

(22) Filed: Dec. 14, 2018

Related U.S. Application Data
(63) Continuation-in-part of application No. 15/878,275, filed on Jan. 23, 2018.
(60) Provisional application No. 62/598,644, filed on Dec. 14, 2017.
(60) Provisional application No. 62/449,406, filed on Jan. 23, 2017.

(51) Int. Cl. G06Q 30/06; G06T 19/00; G06F 16/9032; G06F 16/903; G06F 16/9038

(52) U.S. Cl. CPC G06Q 30/0643; G06T 19/003; G06F 16/9038; G06F 16/90335; G06F 16/90332

(57) ABSTRACT

Systems and methods for processing queries against a large database of transactions. An initial query is processed by a lead analysis engine, but processing does not stop there; the output of the lead analysis engine is used to provide general context, and is also used to select a further-processing module. Multiple results, from multiple further-processing modules, are displayed in a ranked list (or equivalent). The availability of multiple directions of further analysis helps the user to develop an intuition for what trends and drivers might be behind the numbers. Most preferably the resulting information is used to select one or more objects in an immersive environment. The object(s) so selected are visually emphasized, and displayed to the user along with other query results. Optionally, some analysis modules not only process transaction records, but also process customer data (or other exogenous non-transactional data) for use in combination with the transactional data. The customer data will often be high-level, e.g. demographics by zip code, but this link to exogenous data provides a way to link to very detailed customer data results if available.

### CROSS-REFERENCE

Priority is claimed from U.S. provisional application 62/598,644 filed 14 Dec. 2017, which is hereby incorporated by reference. Priority is also claimed, where available, from Ser. No. 15/878,275 filed 23 Jan. 2018, and therethrough from 62/449,406 filed 23 Jan. 2017, both of which are also hereby incorporated by reference.

### BACKGROUND

The present application relates to computer and software systems, architectures, and methods for interfacing to a very large database which includes detailed transaction data, and more particularly to interfaces which support category managers and similar roles in retail operations.

Note that the points discussed below may reflect the hindsight gained from the disclosed inventions, and are not necessarily admitted to be prior art.

Retailers are struggling to achieve growth, especially in center store categories due to a decline in baskets and trips. Customers are becoming more and more omnichannel each day due to convenience, utilizing in-store and online delivery, and utilizing multi-store trips. Pressure is rising on retailers to blend the convenience of online with an enticing, convenient store: retailers need to drive full and loyal trips to ensure growth. Fill-in Trips are rising with the decline of destination trips, such that twenty fill-in trips might equate to only one destination trip. The only way to offset these cycles is by optimizing offerings so as to solidify customer loyalty.

Customer data and a customer-first strategy are essential in meeting these changing needs. Focusing on inventory and margin only goes so far with the modern, ever-demanding customer, and retailers and CPGs must collaborate in order to achieve growth.

Retailers are realizing that they can receive $$ by sharing their customers' purchase data, and in many cases companies will even pay a premium up front for this data.

A common problem faced by category managers and other high-level business users is that they: a) aren't necessarily data analysts, and even if they are, b) they don't have the time to do necessary analysis themselves, so c) they have to send data to data analysts for answers, who d) have a typical turnaround time of 2-10 days, when e) those answers are needed NOW!

Category Managers are not achieving growth and margin targets. They are extremely busy with daily weekly, monthly and seasonal work. They typically pull data from disparate data and tools, use Excel as their only method of analysis, and cannot make optimal decisions.

The present application teaches, among other innovations, new architecture (and systems and related methods) built around a conversational intelligence architecture system used for retail and CPG (Consumer Packaged Goods) management, especially (but not only) category management. There are a number of components in this architecture, and correspondingly there are a number of innovative teachings disclosed in the present application. While these innovative teachings all combine synergistically, it should be noted that different innovations, and different combinations and subcombinations of these innovations, are all believed to be useful and nonobvious. No disclosed inventions, nor combinations thereof, are disclaimed nor relinquished in any way.

Modern category management requires support for category managers to dig deeply into a large database of individual transactions. (Each transaction can e.g. correspond to one unique item on a cash register receipt.) The various disclosed inventions support detailed response to individual queries, and additionally provide rich enough data views to allow managers to “play around” with live data. This is a challenging interface requirement, particularly in combination with the need for near-real-time response.

The present application teaches that, in order for managers to make the best use of the data interface, it is important to provide answers quickly and in a format which helps managers to reach an intuitive understanding. A correct quantitative response is not good enough: the present application discloses ways to provide query responses which support and enhance the user's deep understanding and intuition.

In the following descriptions, a “user” will typically (but not exclusively) be a category manager in a large retail or CPG operation, i.e. one with tens, hundreds, or thousands of physical locations, and thousands or more of distinct products. Other users (such as store or location managers or higher-level executives) often benefit from this interface, but the category manager is a primary driving instance.

In one group of inventions, user queries are matched to one of a predetermined set of tailored analytical engines. The output of the natural language parser is used to select one of those preloaded query engines as a “lead” analysis engine. The lead analysis engine provides an initial output (preferably graphic) which represents a first-order answer to the parsed query, but this is not (nearly) the end of the process. The lead analysis engine's initial output is displayed to the user, and provides context supporting further interaction.

The preloaded analytical engines are supported by a set of further-analysis modules. (In the presently preferred embodiment, seven different further-analysis modules are present, but of course this number can be varied.) These further-analysis modules intelligently retrieve data from ones of multiple pre-materialized “data cubes,” and accordingly provide further expansion of the response. Preferably the further-analysis modules are run in parallel, and offered to the user in a rank order. This results in a degree of interactivity in query response.

Preferably natural language queries are parsed, e.g. by a conventional parser, and immersive visualizations are used, as output, to immediately illuminate the response to a query. For example, “planogram views” show images of the products on virtual shelves. These are preferably interactive, so that a user can “lift” a (virtual) product off the (virtual) shelf, and thereby see corresponding specific analyses. Note that there is a strong synergy between the natural-language input and the immersive-visualization output. The combination of these two user interfaces provides a fully usable system for users who are not inclined to quantitative thinking. At the same time, users who want to dig into quantitative relationships can easily do so. This versatility would not be available except by use of both of these user interface aspects.

A further feature is the tie in to exogenous customer data. The “Customer360” module provides a deep insight into customer behaviors and differentiation. When this module is present, queries for which the knowledge of individual customers' activities would be helpful can be routed to this module.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 shows an overview of operations in the preferred implementation of the disclosed inventions.

FIG. 2 combines an entity relationship diagram with indications of the information being transferred. This diagram schematically shows the major steps in getting from a natural language query to an immersive-environment image result.

FIG. 3 shows a different view of implementation of the information flows and processing of FIG. 2.

FIG. 4A shows how the different analytical module outputs are ranked to provide “highlights” for the user to explore further. From such a list, users can select “interesting” threads very quickly indeed.

FIGS. 4B and 4C show two different visualization outputs.

FIG. 5A is a larger version of FIG. 4C, in which all the shelves of a store are imaged. Some data can be accessed from this level, or the user can click on particular aisles to zoom in.

FIG. 5B shows how selection of a specific product (defined by its UPC) opens a menu of available reports.

FIG. 6 shows how a geographic display can be used to show data over a larger area; in this example, three geographic divisions of a large retail chain are pulled up for comparison.

FIG. 7 shows how broad a range of questions can be parsed. This can include anything from quite specific database queries to fairly vague inquiries.

FIG. 8 shows some examples of the many types of possible queries.

FIG. 9 shows a specific example of a query, and the following figures (FIGS. 10A, 10B, and 11) show more detail of its handling. This illustrates the system of FIG. 2 in action.

FIG. 12 shows one sample embodiment of a high-level view of an analytical cycle according to the present inventions.

FIG. 13 shows a less-preferred (upper left) and more-preferred (lower right) ways of conveying important information to the user.

FIG. 14 shows an exemplary interpretive metadata structure.

FIG. 15 generally shows the data sets which are handled, with daily or weekly updating. The right side of this Figure shows how pre-aggregated data is generated offline, so that user queries can access these very large data sets with near-realtime responsiveness.

FIG. 16 shows some sample benefits and details of the Customer 360 modules.

FIGS. 17A-17B show two different exemplary planogram views.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application teaches new architecture and systems and related methods for a conversational intelligence architecture system used in a retail setting. There are a number of components in this architecture, and correspondingly there are a number of innovative teachings disclosed in the present application. While these innovative teachings all combine synergistically, it should be noted that different innovations, and different subcombinations of these innovations, are all believed to be useful and nonobvious. No disclosed inventions, nor combinations thereof, are disclaimed nor relinquished in any way.

In one group of inventions, user queries are matched to one of a predetermined set of tailored analytical engines. (For example, in the presently preferred embodiment, 13 different analytical engines are present, but of course this number can be varied.) The output of the natural language parser is used to select one of those preloaded query engines as a “lead” analysis module. The lead analysis engine provides a graphic output representing an answer to the parsed query, but this is not (nearly) the end of the process. The lead analysis engine's initial output is displayed to the user, and provides context supporting further interaction. These analytical engines intelligently direct a query to the right one of multiple pre-materialized “data cubes” —seven are used in the current preferred implementation.

The preloaded analytical engines are supported by a set of further-analysis modules. (In the presently preferred embodiment, seven different further-analysis modules are present, but of course this number can be varied.) These further-analysis modules intelligently retrieve data (from the data cubes) and run analyses corresponding to further queries within the context of the output of the lead analysis engine.

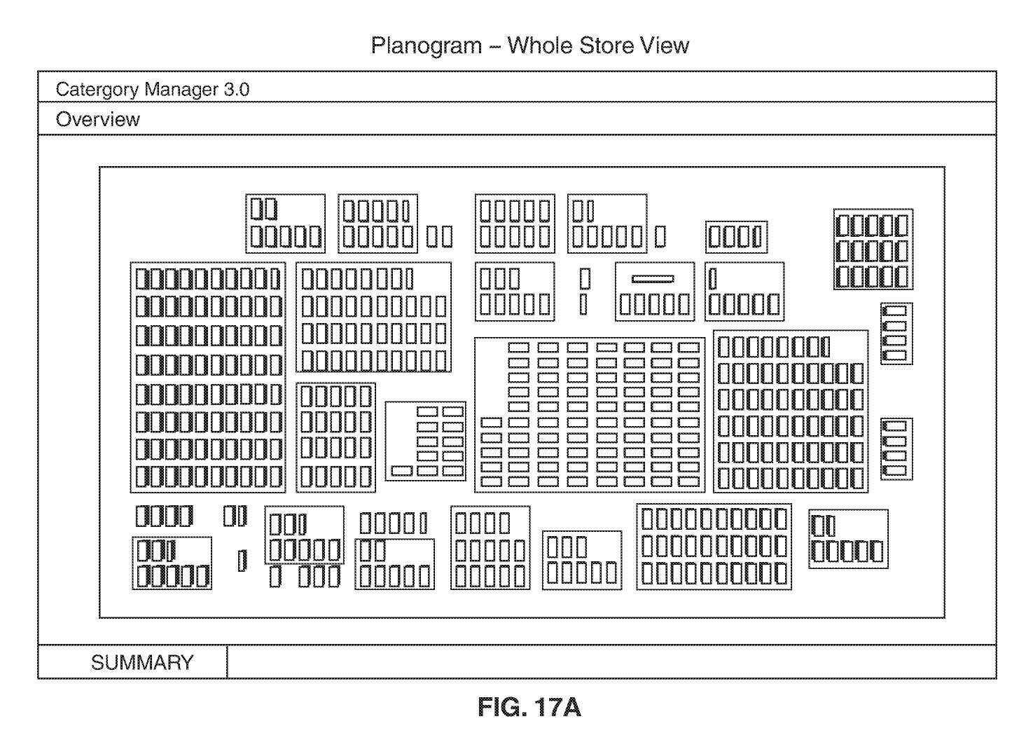

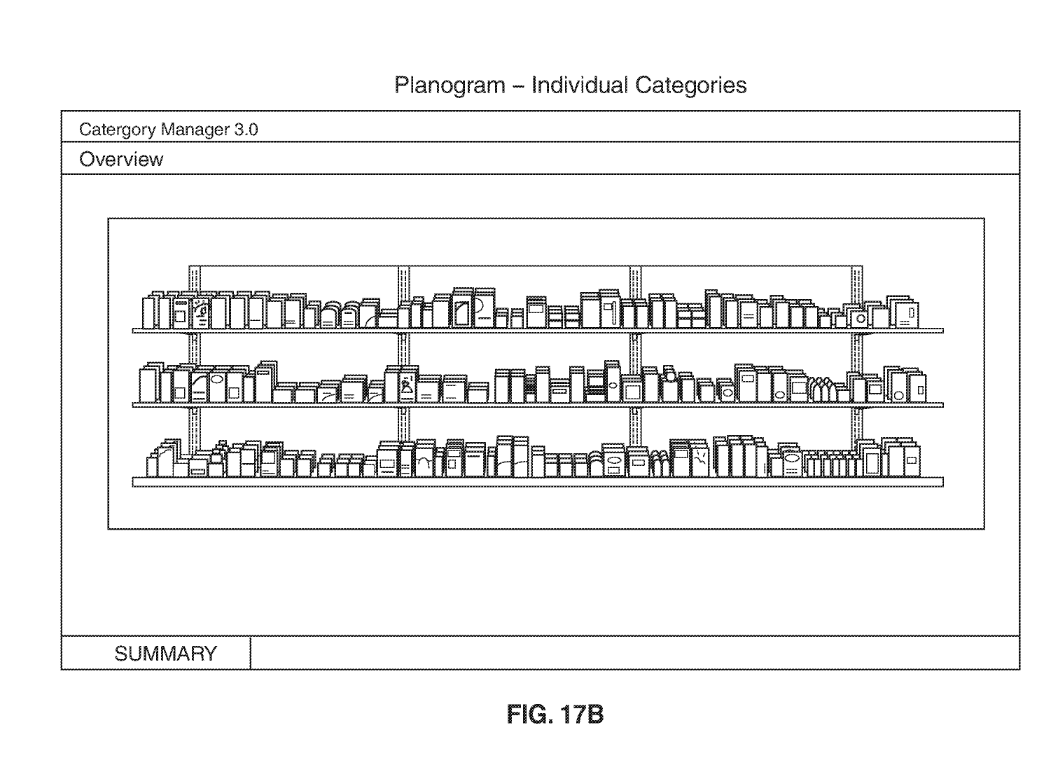

Preferably natural language queries are parsed, e.g. by a conventional parser, and immersive visualizations are used, as output, to immediately illuminate the response to a query. For example, “planogram views” (as seen in e.g. FIGS. 17A-17B) show images of the products on virtual shelves. These are preferably interactive, so that a user can “lift” a (virtual) product off the (virtual) shelf, and thereby see corresponding specific analyses.

Note that there is a strong synergy between the natural-language input and the immersive-visualization output. The combination of these two user interfaces provides a fully usable system for users who are not inclined to quantitative thinking. At the same time, users who want to dig into quantitative relationships can easily do so. This versatility would not be available except by use of both of these user interface aspects.

The further-analysis modules too are not the end of the operation. For each query, each further-analysis module is scored on its effect upon the initial query. These results are displayed in relevance order in the “intelligence insight”. The methodology for calculating the relevance score in each further-analysis module is standardized so these multiple scores can justifiably be ranked together.

A further feature is the tie-in to exogenous data, such as customer data. The “Customer360” module provides a deep insight into customer behaviors and differentiation. When this module is present, queries for which the knowledge of individual customers' activities would be helpful can be routed to this module.

This optional expansion uses an additional dataset AND analytical modules and knowledge base to provide a wider view of the universe. Using the above architecture, queries can be routed to the customer database or the sales database as appropriate. The “Customer360” module permits the introduction of e.g. other external factors not derivable from the transactional data itself.

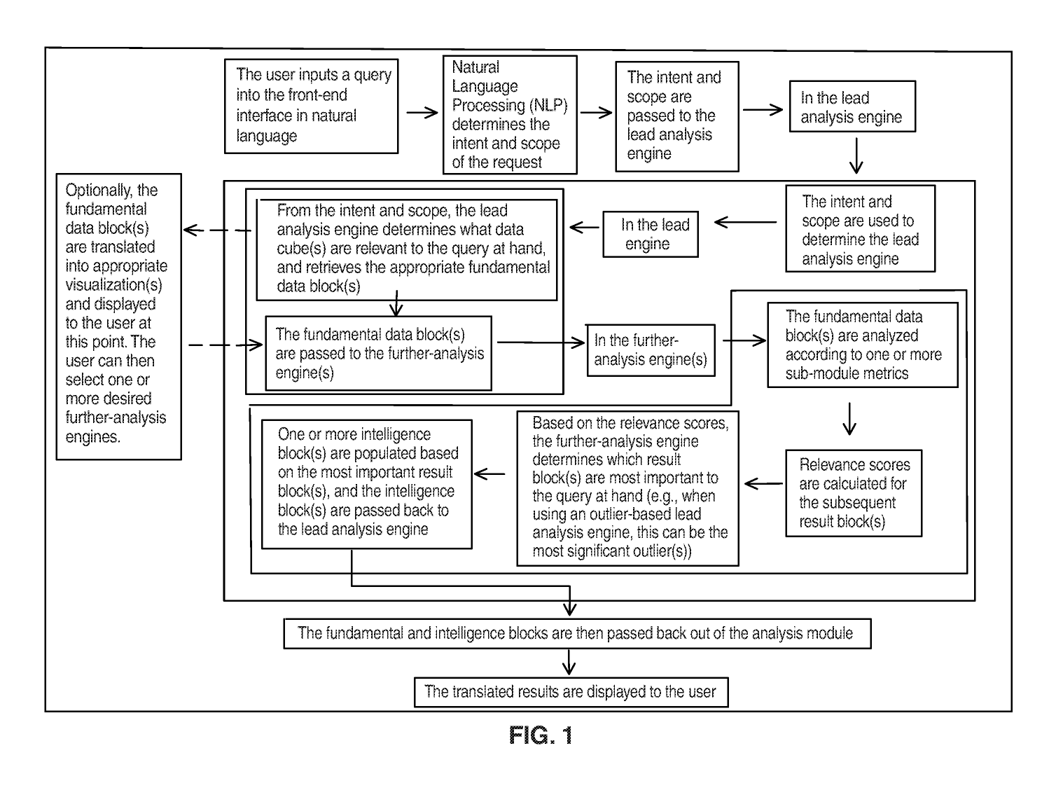

In one sample embodiment like that of FIG. 1, a full query cycle, from user input to final output, can be e.g. as follows:
a. The user inputs a query into the front-end interface in natural language;
b. Natural Language Processing (NLP) determines the intent and scope of the request;
c. The intent and scope are passed to the analysis module;
d. In the analysis module:
   i. The intent and scope are used to determine the lead analysis engine;
   ii. In the lead analysis engine:
      1. From the intent and scope, the lead analysis engine determines what data cube(s) are relevant to the query at hand, and retrieves the appropriate fundamental data block(s);
         A. In some embodiments, the fundamental data block(s) are translated into appropriate visualization(s) and displayed to the user at this point. The user can then select one or more desired further-analysis engines. In other embodiments, the intent and scope include the selection of one or more further-analysis modules, and the fundamental data block(s) are returned later. In still other embodiments, this can be different.
      2. The fundamental data block(s) are passed to the further-analysis engine(s);
      3. In the further-analysis engine(s):
         A. The fundamental data block(s) are analyzed according to one or more sub-module metrics;
         B. Relevance scores are calculated for the subsequent result block(s);
         C. Based on the relevance scores, the further-analysis engine determines which result block(s) are most important to the query at hand (e.g., when using an outlier-based lead analysis engine, this can be the most significant outlier(s));
         D. One or more intelligence block(s) are populated based on the most important result block(s), and the intelligence block(s) are passed back to the lead analysis engine;
      4. The lead analysis engine then returns the fundamental and intelligence blocks;
   iii. The fundamental and intelligence blocks are then passed back out of the analysis module;
e. The fundamental and intelligence blocks are translated into natural language results, visualizations, and/or other means of usefully conveying information to the user, as appropriate; and
f. The translated results are displayed to the user.

Three aspects of the instant inventions together provide a holistic solution which is unique in the industry:

1) Simple Business Natural Language Questions: Simple natural-language business questions result in clear, decisive, insightful answers.

2) Powered by AI Technology: AI techniques that are both cutting-edge and also based on solutions that have evolved from years of analytical IP that have driven Symphony's customers now delivered in seconds.

3) Extremely Fast Datasets: Incredibly fast datasets, honed to deliver lightning instantaneous data for AI to consume, provide substantially real-time analysis that delivers answers when the user needs them, not days or weeks later.

Data cubes are essentially one step up from raw transactional data, and are aggregated over one source. A primary source of raw data is transactional data, typically with one line of data per unique product per basket transaction. Ten items in a basket means ten lines of data, so that two years of data for an exemplary store or group might comprise two billion lines of data or more. Data cubes are preferably calculated offline, typically when the source data is updated (which is preferably e.g. weekly).

Data cubes store multiple aggregations of data above the primary transactional data, and represent different ways to answer different questions, providing e.g. easy ways to retrieve division totals by week. Data cubes “slice” and aggregate data one way or another, preloading answers to various queries. Presently, queries are preferably framed in terms of product, geography, time of sale, and customer. These pre-prepared groupings allow near-instantaneous answers to various data queries. Instead of having to search through e.g. billions of rows of raw data, these pre-materialized data cubes anticipate, organize, and prepare data according to the questions addressed by e.g. the relevant led analysis engine(s).

“FACTS” is a mnemonic acronym which refers to: the Frequency of customer visits, Advocated Categories the customer buys, Total Spend of the customer; these elements give some overall understanding of customers' engagement and satisfaction with a retailer. This data is used to compile one presently-preferred data cube.

Another presently-preferred data cube, known as TruPrice™, looks at customer analysis, e.g. by identifying whether certain customers are more price-driven, more quality-driven, or price/quality neutral.

People who need the analysis (particularly but not exclusively category managers): a) aren't necessarily data analysts, and even if they are, b) don't have the time to do analysis themselves, so c) have to send data to data analysts, which d) has a typical turnaround time of ˜2-10days, when e) they need those answers NOW! The present inventions can give those crucial answers in seconds or minutes, allowing retailers and CPGs the necessary flexibility to react to emerging trends in near-real-time.

Presently-preferred further-analysis modules address data according to seven analytical frameworks (though of course more, fewer, and/or different further-analysis modules are possible:

1—Who

2—Where

3—What Sells More

4—When

5—What Sells Together

6—Trial Vs. Repeat Sales

7—Sales Drivers

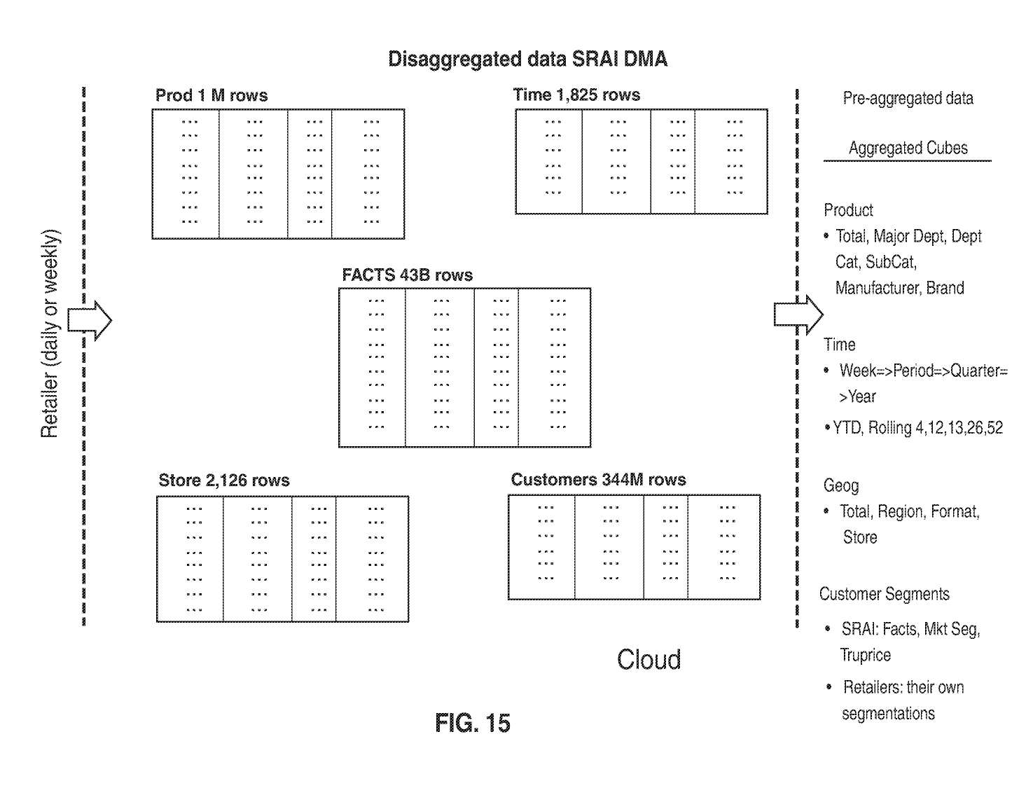

Some possible aggregated data cubes address the following considerations, as seen in e.g. FIG. 15:

By Product: includes sales sorted by e.g. total, major department, department category, subcategory, manufacturer, and brand.

By Time: includes sales sorted by e.g. week, period, quarter, and year, as well as year-to-date and rolling periods of e.g. 4, 12, 13, 26, and 52 weeks.

By Geography/Geographical Consideration: includes sales sorted by e.g. total, region, format, and store.

By Customer Segments: includes sales as categorized according to data from e.g. FACTS, market segment, TruPrice, and/or retailer-specific customer segmentations.

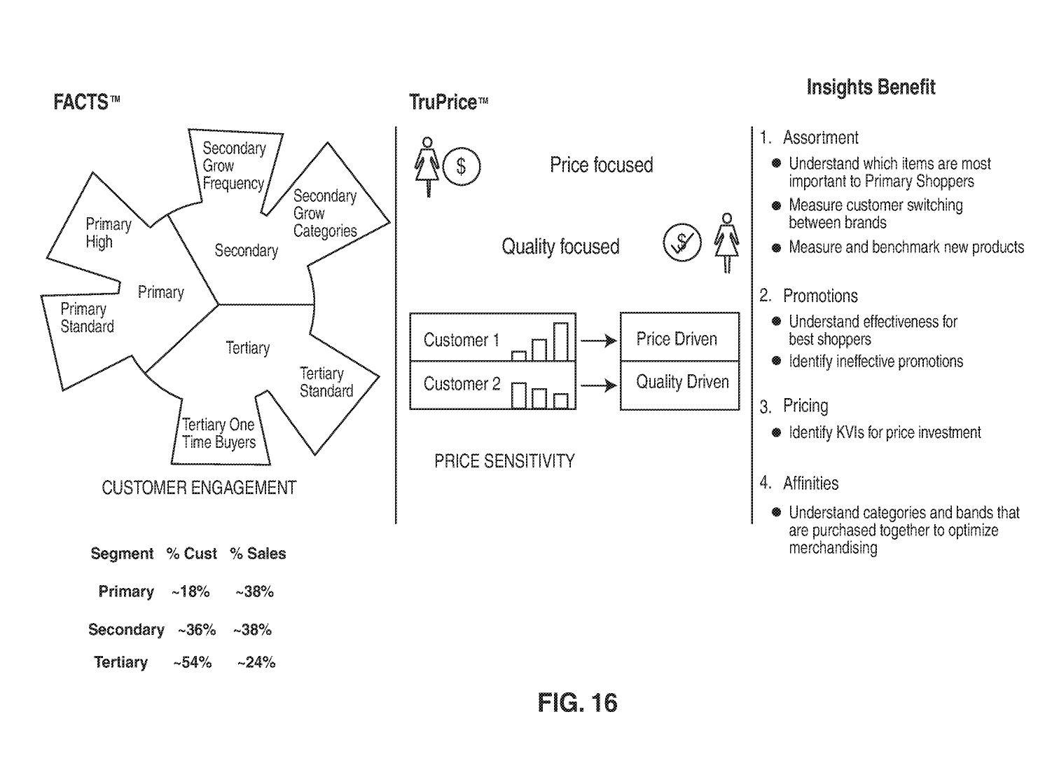

The present inventions can provide the following insight benefits, as seen in e.g. FIG. 16:

Assortment: Understand which items are most important to Primary shoppers; Measure customer switching among brands; Measure and benchmark new products.

Promotions: Understand effectiveness for best shoppers; Identify ineffective promotions.

Pricing: Identify KVIs for investment.

Affinities: Understand categories and brands that are purchased together to optimize merchandising.

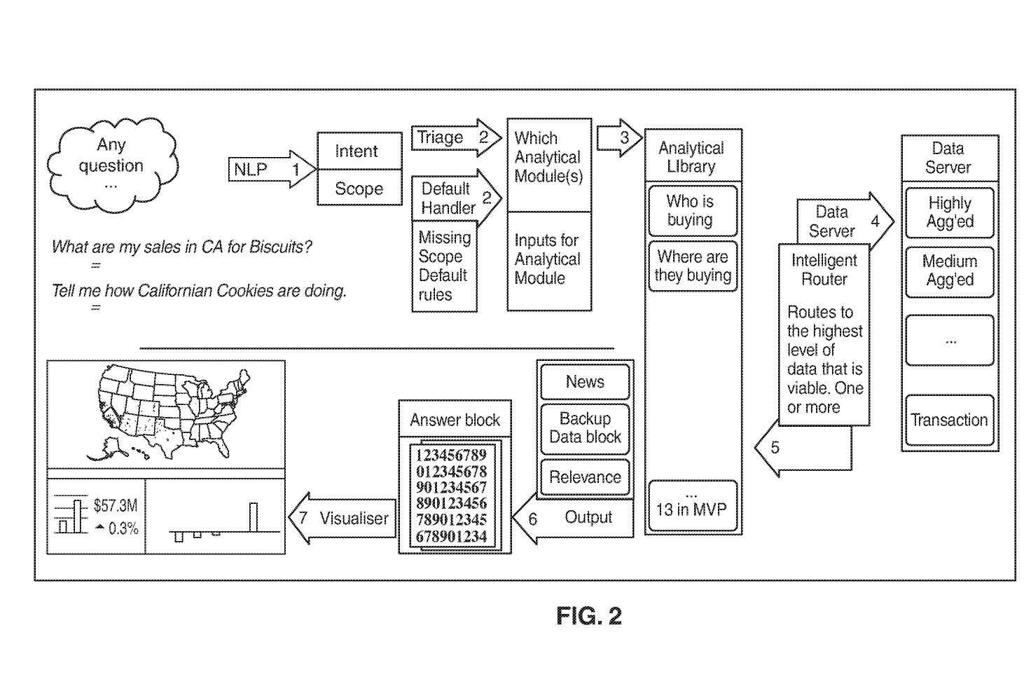

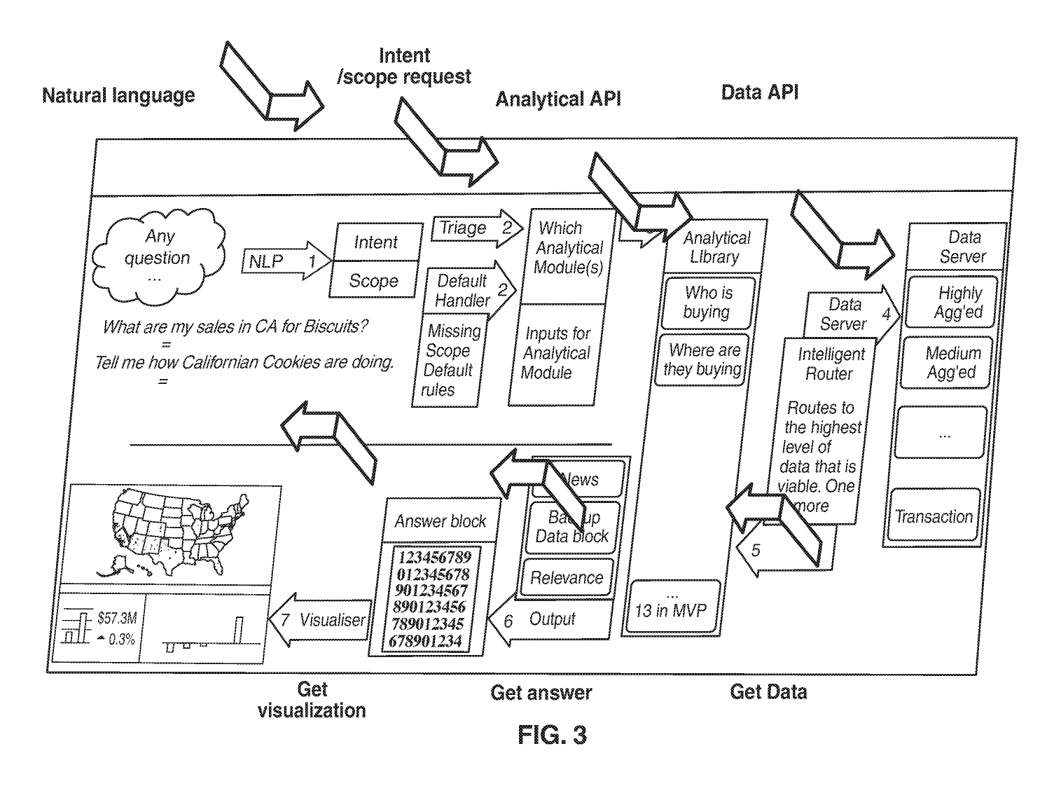

One sample embodiment can operate as follows, as seen in e.g. FIGS. 2 and 3.

A) Preferably natural language queries are parsed, e.g. by a conventional parser.

B) The queries are matched to one of a predetermined set of tailored analytical engines. (In the presently preferred embodiment, 13 different analytical engines are present, but of course this number can be varied.) The output of the natural language parser is used to select one of those preloaded query engines as a “lead” analysis engine. These analytical engines can utilize multiple data cubes. The lead analysis engine provides a graphic output representing an answer to the parsed query, but this is not (nearly) the end of the process. The lead analysis engine's initial output is displayed to the user, and provides context supporting further interaction.

C) The preloaded query engines are supported by a set of further-analysis modules. (In the presently preferred embodiment, seven different further-analysis modules are present, but of course this number can be varied.) These further-analysis modules intelligently retrieve data again from the “data cubes” and run analyses corresponding to further queries within the context of the output of the lead analysis engine.

D) The further-analysis modules too are not the end of the operation. Each further-analysis module provides a relevance score in proportion to its relevance to its effect upon the initial query. These are displayed in relevance order in the “intelligence insight”. The methodology for calculating the relevance score in each further-analysis module is standardized so these multiple scores can justifiably be ranked together.

Standardization tables and associated distribution parameters provide metadata tables to tell the front-end interface what is different about a given retailer as compared to other retailers, which might have different conditions. This permits use of metadata to control what data users see, rather than having different code branches for different retailers. These standardization tables address questions like, e.g., “does this particular aspect make sense within this retailer or not, and should it be hidden?” These configuration parameters switch on or off what may or may not make sense for that retailer.

E) Another innovative and synergistic aspect is the connection to immersive visualizations which immediately illuminate the response to a query. A business user can interact by using natural-language queries, and then receive “answers” in a way that is retailer-centric. For example, the “planogram view” shows products on virtual shelves, and also provides the ability to (virtually) lift products off the shelf and see analyses just for that product. This provides the business user with the pertinent answers with no technical barriers.

F) In addition to Sales and Customer Segmentation, knowledge can be added by an additional dataset describing other information on the customers who shop in the store(s) in question. “Customer360” can provide deep insight into customer behaviors beyond what they do in the subject store itself.

Optionally, Customer360 (C360) can provide additional datasets and/or analytical modules to provide a wider view of the universe. Queries can be routed e.g. to the customer database (or other exogenous database) or the sales database, as appropriate.

Customer 360 helps retailers and CPG manufacturers gain a holistic real-time view of their customers, cross-channel, to fuel an AI-enabled application of deep, relevant customer insights. Customer 360 is a first-of-its-kind interactive customer data intelligence system that uses hundreds of shopper attributes for insights beyond just purchasing behavior. Customer 360 can take into consideration other data that influences how customers buy, such as e.g. other competition in the region, advertising in the region, patterns of customer affluence in the region, how customers are shopping online vs. in brick and mortar stores, and the like.

For example, Customer 360 can help the user identify that, e.g., a cut-throat big box store down the block is “stealing” customers from a store, or that a e.g. a new luxury health food store nearby is drawing customers who go to the Whole Foods for luxuries and then come to the user's store for basics.

The user asks a question that defines a scope (e.g. Snacks in California) and an intent (e.g. show me sales development). CMS presents fundamental sales development information related to the defined scope through, e.g., a background view (of a relevant map, store, or other appropriate context), and e.g. sections of an analytical information panel (including e.g. summary, customer segments, and sales trend).

CMS presents additional/“intelligent” information in another section of the analytical information panel. This could be, e.g., one or more information blocks that the system automatically identifies as relevant to explain issues that are impacting the sales development in the current scope, or e.g. an information block that answers an explicit question from the user (e.g. “What are people buying instead of cookies?”).

From a behind-the-scenes perspective, a question (as derived from user interaction with the system) preferably defines at least a scope, e.g. {state: ‘CA’, department: ‘SNACKS’ , dateRange: ‘201601-201652’}, and an intent, e.g. showSales | showTop departments | showSwitching for Cookies.

The front-end user interface contacts the backend information providers according to the scope & intent, and then the backend provides a fundamental info block and several “intelligent information blocks” that can be displayed in the analytical information panel.

Lead analysis engines relate to what the user is looking for, e.g.: outlier data? Whether and why customers are switching to or from competitors? Performance as measured against competitors? Customer loyalty data? Success, failure, and/or other effects of promotional campaigns?

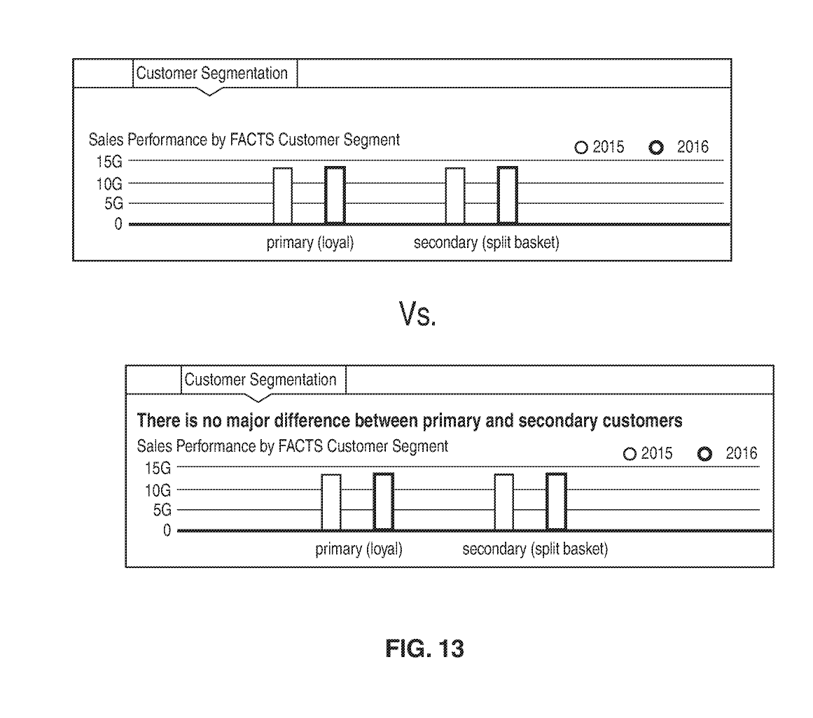

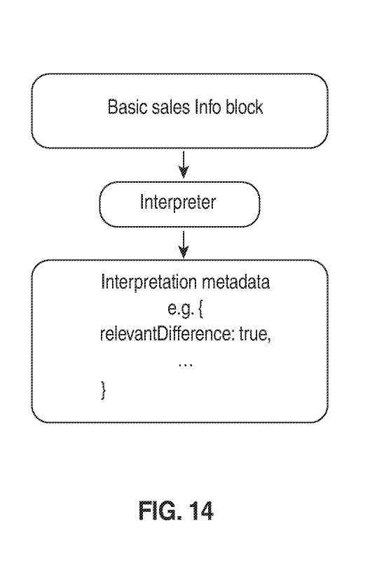

When relevant, fundamental data is most preferably presented together with some level of interpretation, as in e.g. FIG. 13. This can be provided via, e.g., rules hard coded in the user interface, and/or an interpretation “process” that adds metadata to the information block, as in e.g. FIG. 14.

The further-analysis module(s) preferably look at, e.g., which attributes have a relevant impact on sales.

In some embodiments, intelligence domains can include e.g. the following, for e.g. an outlier-based lead analysis engine:

Who is buying, e.g. New customers, Exclusive customers, lost customers, customer segments, Breadth of purchase?

Where are they buying, e.g. Top selling stores, Bottom selling stores, best performing stores, worst performing stores, expansion opportunities, sales by geography?

When are they buying, e.g. Sales by Day of Week, Sales by time

What sells more, e.g. Products switching from, what people buy instead of, top selling products across stores, top selling products by store format, what people buy with . . .

What sells better together, e.g. What are the other products / categories that are bought together? What other brands are customers buying with my brand?

What is the impact of promotions?

What are trial and repeat outcomes, e.g. What are the new product launches in category? How did they perform?

How does loyalty impact growth, e.g. What groups of products are driving new customers into the category? What are my most loyal brands? Which groups of customers have driven growth?

What is the source of volume, e.g. Did I switch sales from one product to another? For this new products what did people used to buy? Do sales come from people new to the category?

Category management reports can include, e.g., an Event Impact Analyzer, which measures the impact of an event against key sales metrics; a Switching Analyzer, which can diagnose what is driving changes in item sales; a Basket Analyzer, which identifies cross-category merchandising opportunities; a Retail Scorecard, which provides high-level business and category reviews by retailer hierarchy and calendar; and numerous other metrics.

FIG. 2 combines an entity relationship diagram with indications of the information being transferred. This diagram schematically shows the major steps in getting from a natural language query to an immersive-environment image result.

Starting with any question, step 1 uses natural language parsing (NLP) to obtain the intent and scope of the question.

Step 2 is a triage step which looks at the intent and scope (from Step 1) to ascertain which analytical module(s) should be invoked, and what should be the initial inputs to the module(s) being invoked.

In Step 3, one or more modules of the Analytical Library are invoked accordingly; currently there are 13 modules available in the Analytical Library, but of course this can change.

In Step 4, the invoked module(s) is directed to one or more of the Data Sources. Preferably intelligent routing is used to direct access to the highest level of data that is viable.

The resulting data loading is labeled as Step 5.

The invoked module(s) of the Analytical Library now provide their outputs, which are ranked according to (in this example) novelty and relevance to the query. This produces an answer in Step 6.

Finally, a visualizer process generates a visually intuitive display, e.g. an immersive environment (Step 7).

FIG. 3 shows a different view of implementation of the information flows and processing of FIG. 2. A natural language query appears, and natural language processing is used to derive intent and scope values. These are fed into the Analytical API, which accordingly makes a selection into the Analytical Library as described above. The invoked analytical modules accordingly use the Data API to get the required data, and then generate an answer. The answer is then translated into a visualization as described.

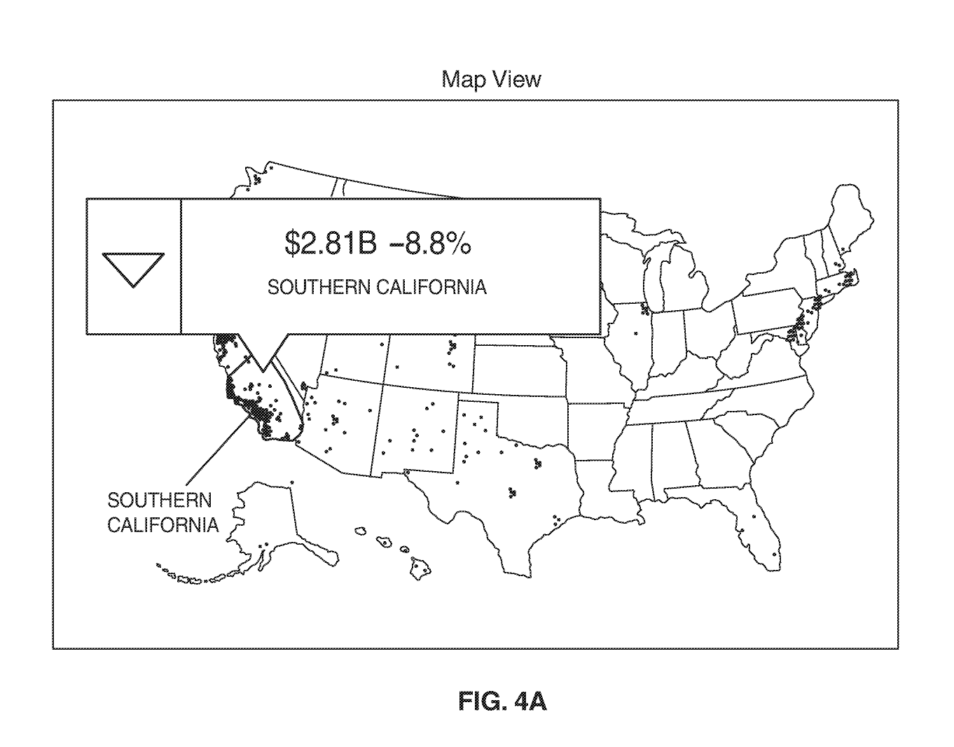

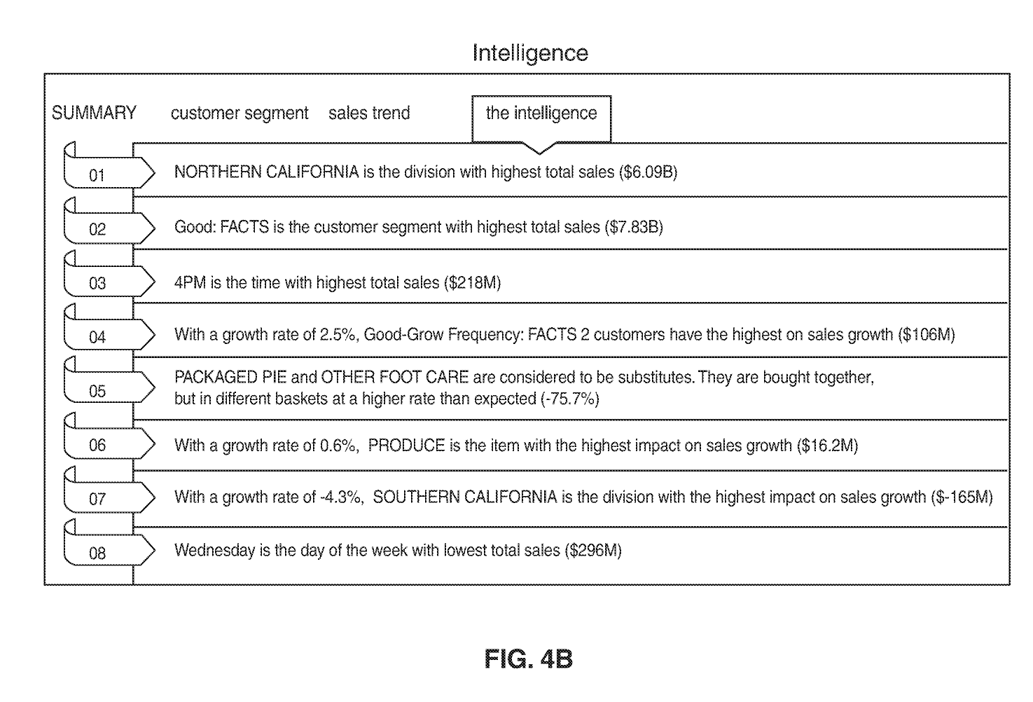

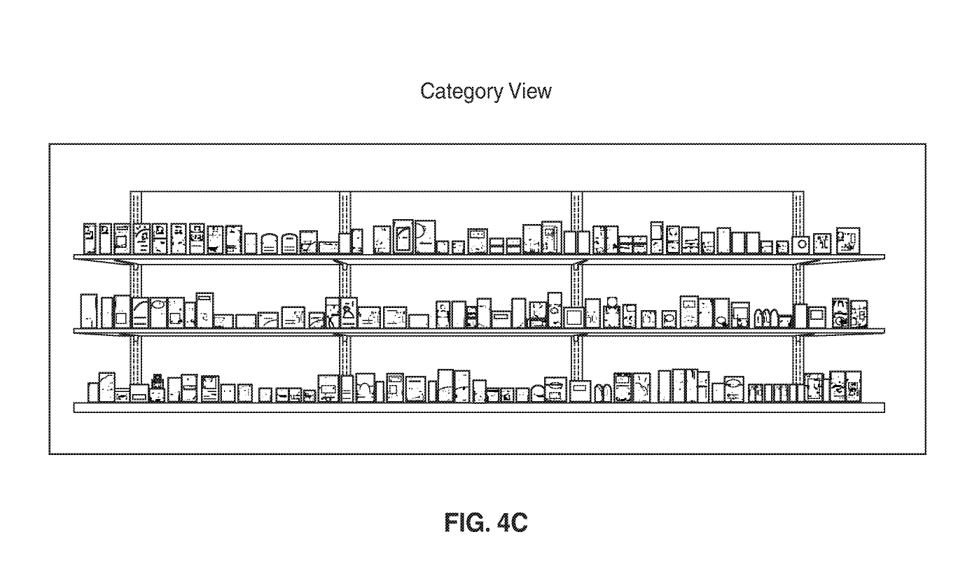

FIG. 4A shows how the different analytical module outputs are ranked to provide “highlights” for the user to explore further. From such a list, users can select “interesting” threads very quickly indeed.

FIGS. 4B and 4C show two different visualization outputs. FIG. 4B shows a geographic display, where data is overlaid onto a map.

FIG. 4C shows a Category display, where a category manager can see an image of the retail products in a category, arranged on a virtual retail display. This somewhat-realistic display provides a useful context for a category manager to change display order, space, and/or priorities, and also provides a way to select particular products for follow-up queries.

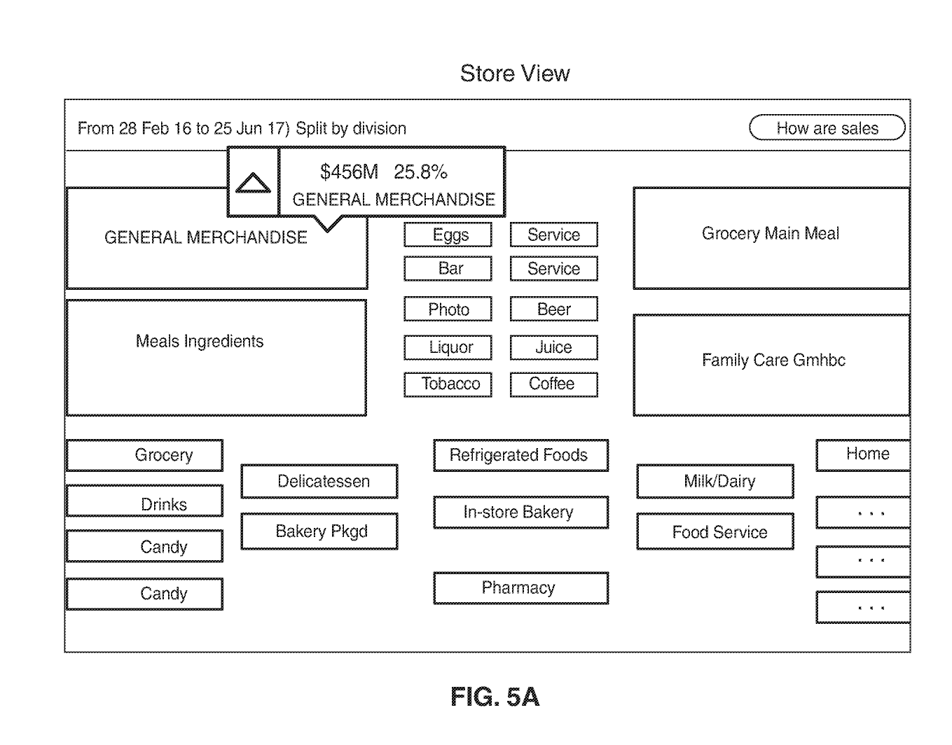

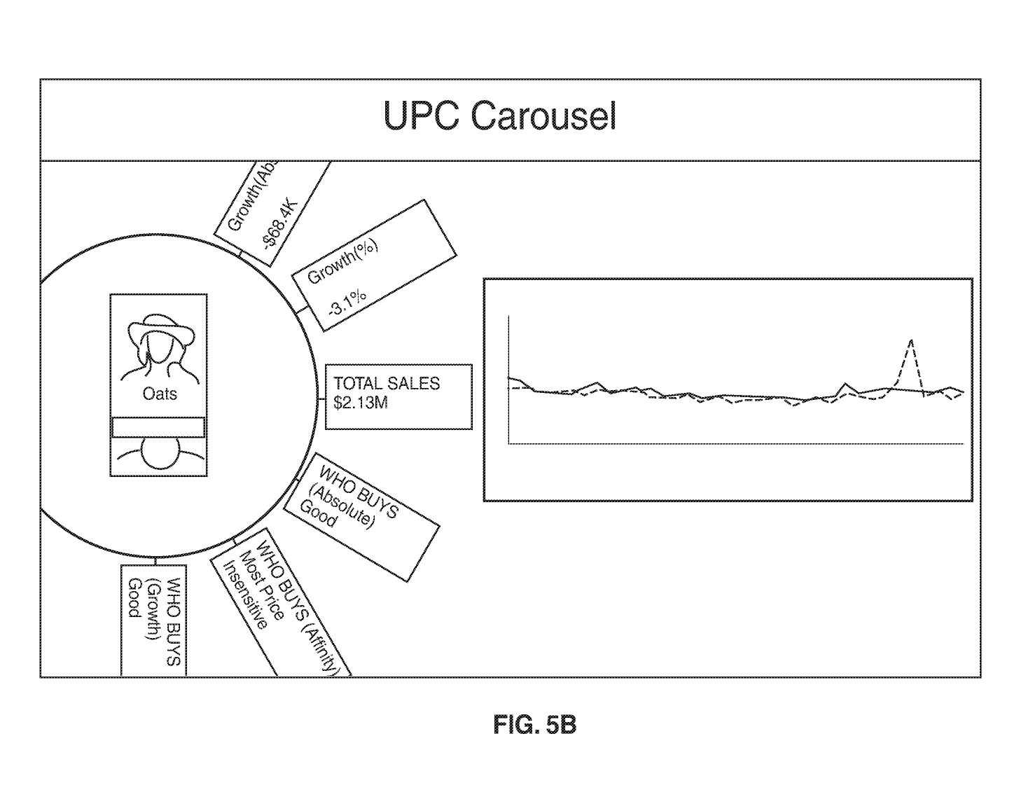

FIG. 5A is a larger version of FIG. 4C, in which all the shelves of a store are imaged. Some data can be accessed from this level, or the user can click on particular aisles to zoom in.

FIG. 5B shows how selection of a specific product (defined by its UPC) opens a menu of available reports.

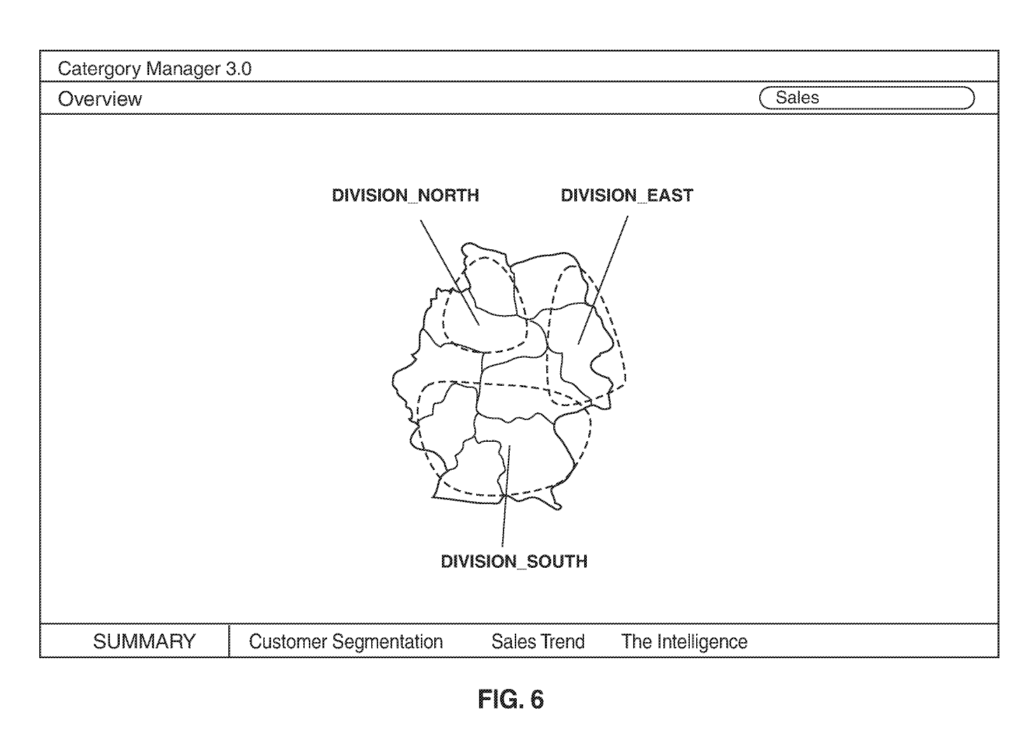

FIG. 6 shows how a geographic display can be used to show data over a larger area; in this example, three geographic divisions of a large retail chain are pulled up for comparison.

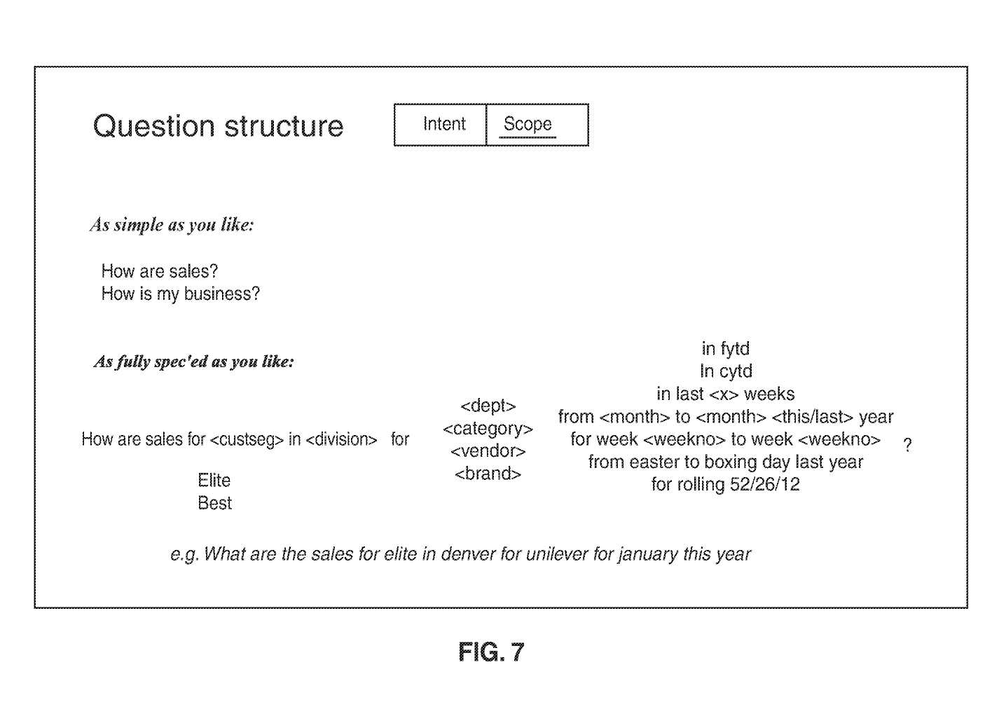

FIG. 7 shows how broad a range of questions can be parsed. This can include anything from quite specific database queries to fairly vague inquiries.

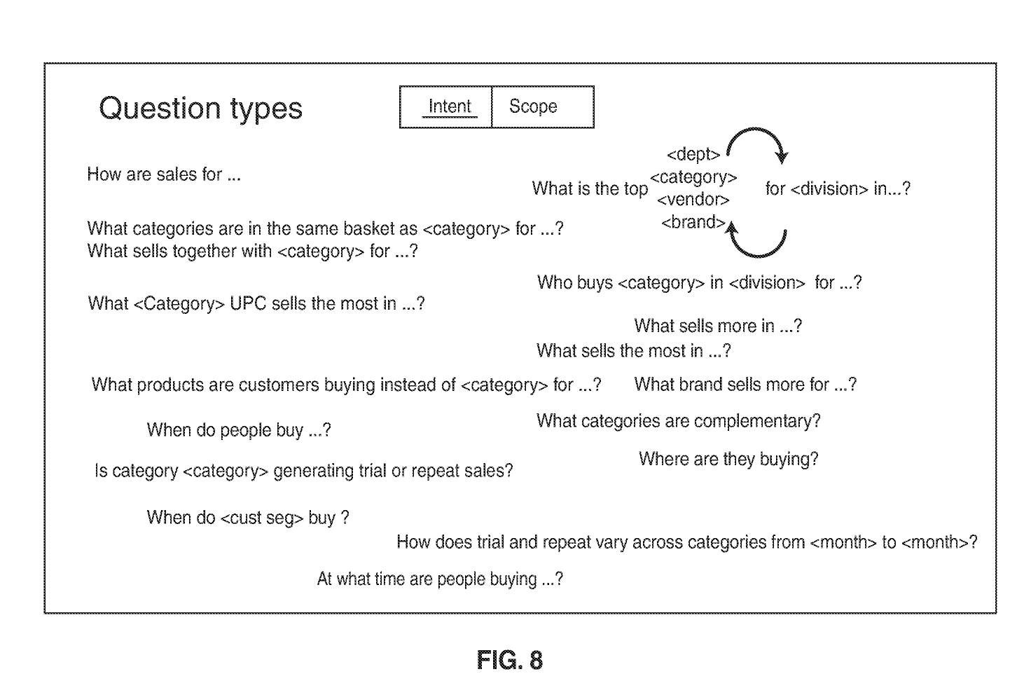

FIG. 8 shows some examples of the many types of possible queries.

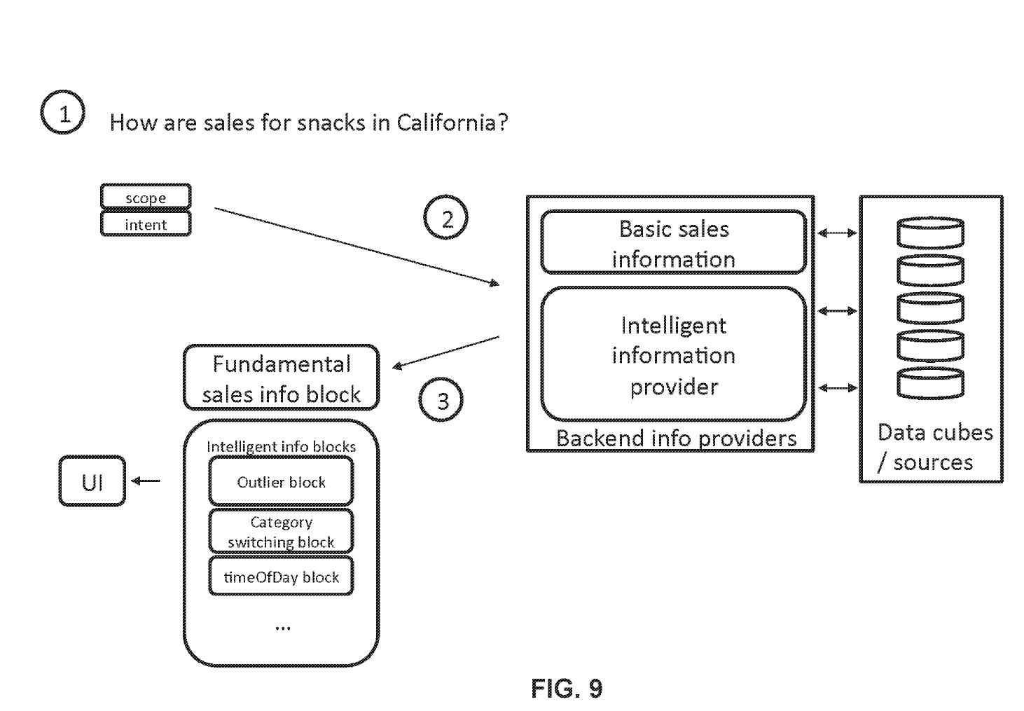

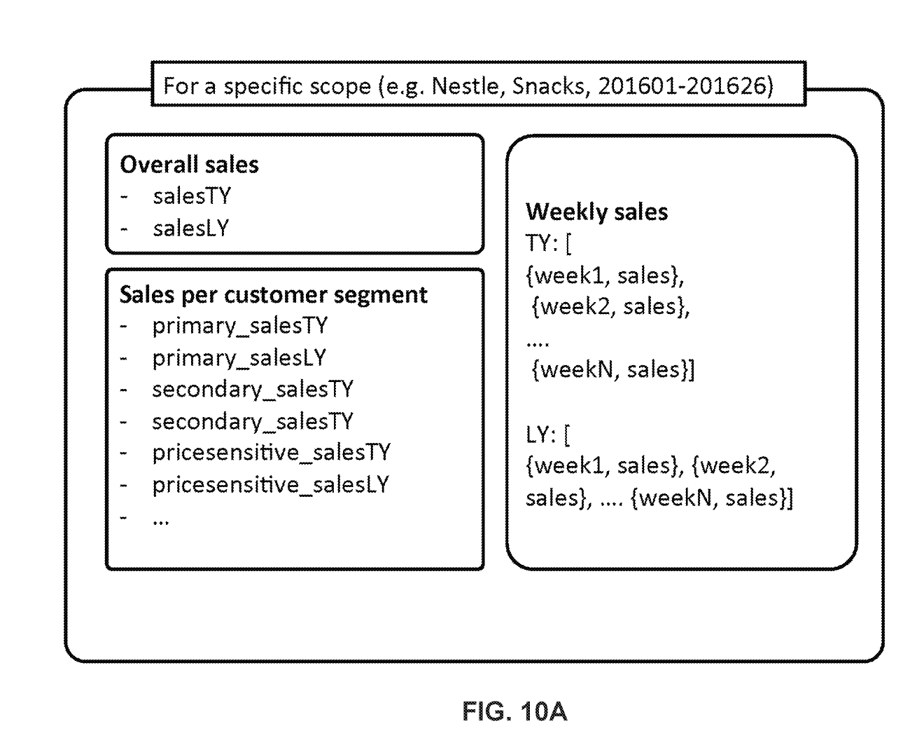

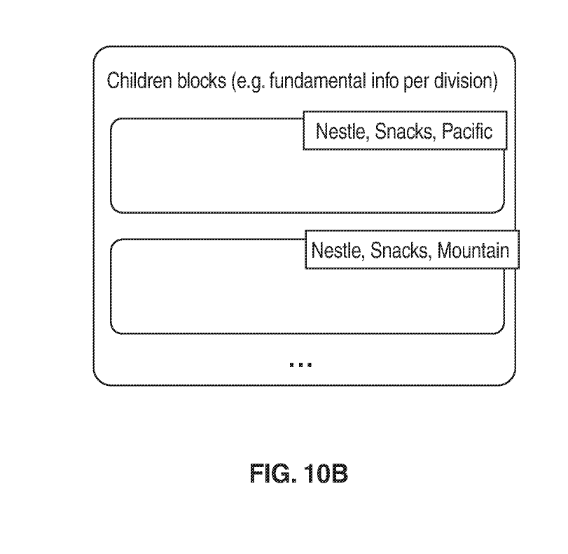

FIG. 9 shows a specific example of a query, and the following figures (FIGS. 10A, 10B, and 11) show more detail of its handling. This illustrates the system of FIG. 2 in action.

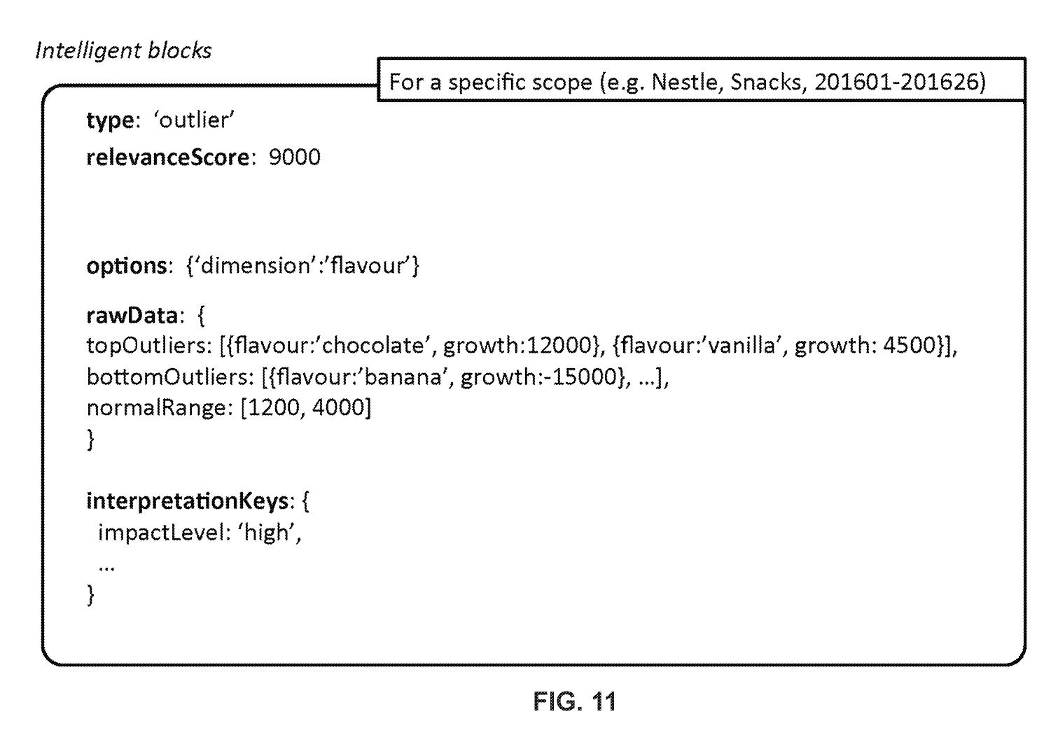

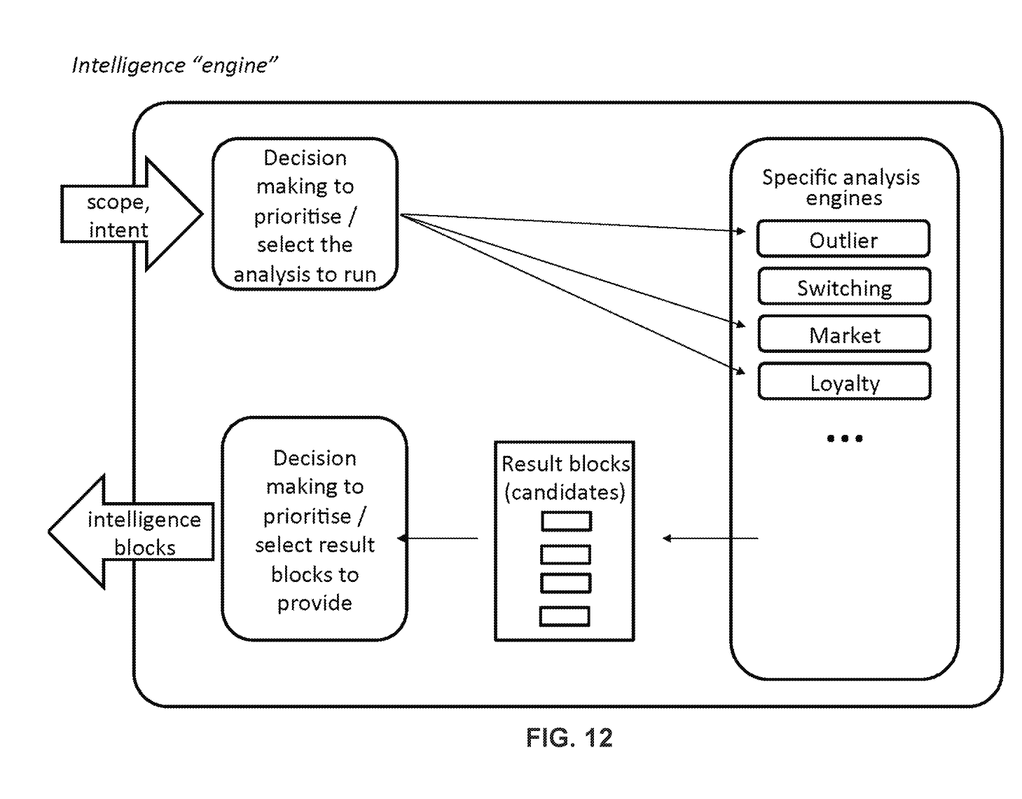

FIG. 12 shows one sample embodiment of a high-level view of an analytical cycle according to the present inventions.

FIG. 13 shows a less-preferred (upper left) and more-preferred (lower right) ways of conveying important information to the user.

Appendices A-G show exemplary analytical specifications for the seven presently-preferred further-analysis modules, and Appendix H shows exemplary source data for Appendices A-G. These appendices are all hereby incorporated by reference in their entirety.

### Explanation of Terminology

CMS/C-Suite: Category Management Suite

KVI can refer both to Key Value Indicators, and also to Key Value Items, e.g. products within a category the user may wish to track, such as those that strongly drive sales in its category; indicative of important products for price investment.

C360: Customer 360° Intelligence

CPG: Consumer Packed Goods represent the field one step earlier and/or broader in the supply chain than retail. Well-known CPGs include, e.g., Proctor & Gamble™, Johnson & Johnson™, Clorox™, General Mills™, etc., where retail is direct client/customer/consumer sales, such as e.g. Target™, Albertsons™, etc. CPG is not strictly exclusive with retail; CPG brands like e.g. New Balance, clothing brands like Prada and Gucci, some spice companies, and others are both CPG and retail, in that they sometimes have their own stores in addition to selling to retailers.

### Advantages

The disclosed innovations, in various embodiments, provide one or more of at least the following advantages. However, not all of these advantages result from every one of the innovations disclosed, and this list of advantages does not limit the various claimed inventions.
Fast response to managers' database inquiries;
Intuitive presentation of query responses;
Augmentation of transactional data with exogenous data, such as customer data; and
Automated data access, analysis and decision support.

According to some but not necessarily all embodiments, there is provided: A method for processing queries into a large database of transactions, comprising the actions of: receiving a query from a user, and accordingly selecting one of a predetermined set of analysis modules to be a lead analysis module; applying the lead analysis module to transaction data to thereby provide an initial output, and also providing a ranking of multiple further-analysis modules, while also running the multiple further-analysis modules on the transaction data; allowing the user to select at least one of the further-analysis modules, and providing a corresponding output to the user.

According to some but not necessarily all embodiments, there is provided: a method for processing queries into a large database of transactions, comprising the actions of: receiving and parsing a natural language query from a user, and accordingly selecting one of a predetermined set of analysis modules to be a lead analysis module; applying the lead analysis module to a large set of transaction data to thereby provide an initial output, and also providing a ranking of multiple further-analysis modules, while also running the multiple further-analysis modules on the transaction data; allowing the user to select at least one of the further-analysis modules, and displaying the results from the selected further-analysis module to the user with an immersive environment, in which items relevant to the query are made conspicuous.

According to some but not necessarily all embodiments, there is provided: A method for processing queries into a large database of transactions, comprising the actions of: receiving a query from a user, and accordingly selecting one of a predetermined set of analysis modules to be a lead analysis module; applying the lead analysis module to transaction data to thereby provide an initial output, and also providing a ranking of multiple further-analysis modules, while also running the multiple further-analysis modules on the transaction data; wherein at least one said analysis module operates not only on transactional data, but also on customer data which is not derived from transactional data; and allowing the user to select at least one of the further-analysis modules, and providing a corresponding output to the user.

According to some but not necessarily all embodiments, there is provided: A method for processing queries into a large database of transactions, comprising the actions of: receiving and parsing a natural language query from a user, and accessing a database of transactions to thereby produce an answer to the query; and displaying an immersive environment to the user, in which objects relevant to the query are made conspicuous.

According to some but not necessarily all embodiments, there is provided: A method for processing queries into a large database of transactions, comprising the actions of: when a user inputs a natural-language query into the front-end interface, natural language processing determines the intent and scope of the request, and passes the intent and scope to the analysis module; in the analysis module, the intent and scope are used to select a primary analysis engine; from the intent and scope, the primary analysis engine determines what data cube(s) are relevant to the query at hand, and retrieves the appropriate fundamental data block(s); the fundamental data block(s) are passed to the specific/secondary analysis engine(s); in the specific/secondary analysis engine(s): the fundamental data block(s) are analyzed according to one or more sub-module metrics; relevance scores are calculated for the subsequent result block(s); and, based on the relevance scores, the specific/secondary analysis engine determines which result block(s) are most important to the query at hand; one or more intelligence block(s) are populated based on the most important result block(s), and the intelligence block(s) are passed back to the primary analysis engine; the primary analysis module then returns the fundamental and intelligence blocks; the fundamental and intelligence blocks are then passed back out of the analysis module, whereupon the fundamental and intelligence blocks are translated into natural language results, visualizations, and/or other means of usefully conveying information to the user, as appropriate; and the translated results are displayed to the user.

According to some but not necessarily all embodiments, there is provided: Systems and methods for processing queries against a large database of transactions. An initial query is processed by a lead analysis engine, but processing does not stop there; the output of the lead analysis engine is used to provide general context, and is also used to select a further-processing module. Multiple results, from multiple further-processing modules, are displayed in a ranked list (or equivalent). The availability of multiple directions of further analysis helps the user to develop an intuition for what trends and drivers might be behind the numbers. Most preferably the resulting information is used to select one or more objects in an immersive environment. The object(s) so selected are visually emphasized, and displayed to the user along with other query results. Optionally, some analysis modules not only process transaction records, but also process customer data (or other exogenous non-transactional data) for use in combination with the transactional data. The customer data will often be high-level, e.g. demographics by zip code, but this link to exogenous data provides a way to link to very detailed customer data results if available.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, as well as some features which can be implemented synergistically with the inventions claimed below, may be found in the following US patent applications. All of these applications have at least some common ownership, copendency, and inventorship with the present application, and all of them, as well as any material directly or indirectly incorporated within them, are hereby incorporated by reference: U.S. application Ser. No. 15/878,275 (SEYC-11) and Ser. No. 62/349,543 (SEYC-10).

It should be noted that, while the terms “retail” and “retailer” are used throughout this application, the terms are used for simplicity, and should be understood to include both retail and CPG (Consumer Packed Goods) applications.

Some presently-preferred embodiments use Google to capture speech, followed by Google Dialog Flow for parsing.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A method for processing queries into a large database of transactions, comprising the actions of:
receiving a query from a user, and accordingly selecting one of a predetermined set of analysis modules to be a lead analysis module;
applying the lead analysis module to transaction data to thereby provide an initial output, and also providing a ranking of multiple further-analysis modules, while also running the multiple further-analysis modules on the transaction data;
allowing the user to select at least one of the further-analysis modules, and providing a corresponding output to the user.

2. The method of claim 1, wherein the query can be a natural-language query; and further comprising the initial step of parsing the natural-language query.

3. The method of claim 1, further comprising the subsequent step of displaying an immersive environment to the user to represent the output of at least one further-analysis module.

4. A method for processing queries into a large database of transactions, comprising the actions of:
receiving and parsing a natural language query from a user, and accordingly selecting one of a predetermined set of analysis modules to be a lead analysis module;
applying the lead analysis module to a large set of transaction data to thereby provide an initial output, and also providing a ranking of multiple further-analysis modules, while also running the multiple further-analysis modules on the transaction data;
allowing the user to select at least one of the further-analysis modules, and
displaying the results from the selected further-analysis module to the user with an immersive environment, in which items relevant to the query are made conspicuous.

5. The method of claim 4, wherein the immersive environment corresponds to a view of products displayed for sale in a physical retail location.

6. A method for processing queries into a large database of transactions, comprising the actions of:
receiving a query from a user, and accordingly selecting one of a predetermined set of analysis modules to be a lead analysis module;
applying the lead analysis module to transaction data to thereby provide an initial output, and also providing a ranking of multiple further-analysis modules, while also running the multiple further-analysis modules on the transaction data;
wherein at least one said analysis module operates not only on transactional data, but also on customer data which is not derived from transactional data; and
allowing the user to select at least one of the further-analysis modules, and providing a corresponding output to the user.

7. The method of claim 6, wherein the query can be a natural-language query; and further comprising the initial step of parsing the natural-language query.

8. The method of claim 6, further comprising the subsequent step of displaying an immersive environment to the user to represent the output of at least one further-analysis module.

9-15. (canceled)
